(19) United States
(12) Patent Application Publication
(10) Pub. No.: US 2024/0239217 A1
(43) Pub. Date: Jul. 18, 2024

(54) SYSTEM FOR CONTROLLING ELECTRIC POWER OF VEHICLE BATTERY AND METHOD FOR DRIVING THE SAME

(71) Applicant: HL MANDO CORPORATION, Gyeonggi-do (KR)

(72) Inventor: Bongyeon CHOI, Gyeonggi-do (KR)

(21) Appl. No.: 18/401,337

(22) Filed: Dec. 30, 2023

(30) Foreign Application Priority Data
Jan. 12, 2023 (KR) 10-2023-0004973

(51) Int. Cl. B60L 53/20; H02J 7/00

(52) U.S. Cl. CPC B60L 53/20; H02J 7/0063; B60L 2210/10; B60L 2210/40; H02J 2207/20

(57) ABSTRACT

A vehicle battery output system includes: a DC-DC (direct current-direct current) converter configured to receive a direct current from a vehicle battery and convert the direct current into another direct current; a DC-AC (direct current-alternating current) inverter configured to convert the another direct current of the vehicle battery, converted by the DC-DC converter, into an alternating current; a controller configured to receive an input current, an output voltage, and a reference voltage and calculate a switching frequency modulation index to generate a control signal for controlling the DC-DC converter; and a DC (direct current) link disposed between the DC-DC converter and the DC-AC inverter and including a capacitor.

### CROSS-REFERENCE TO RELATED APPLICATION

This application claims priority to and the benefit of Korean Patent Application No. 10-2023-0004973, filed on Jan. 12, 2023, in the Korean Intellectual Property Office (KIPO), the disclosure of which is incorporated by reference herein in its entirety.

### TECHNICAL FIELD

The present disclosure generally relates to a system for controlling electric power of a vehicle battery and a method for driving the same, and more particularly, to a vehicle battery output system which may reduce a ripple of a current input to the vehicle battery output system and to a method for driving the vehicle battery output system.

### BACKGROUND

A vehicle battery output system, so-called V2L (Vehicle to Load), can enable an electric vehicle to provide regular AC power to loads. In the V2L system, the electronic energy of a vehicle battery can be used to supply power to appliances operated on line voltage. For instance, the power drawn from the electric vehicle is made available at a socket outlet which can be located in the cab of the vehicle and/or on an outside of the vehicle.

Korean Patent No. 10-2339935 “Uninterruptible power supply with rectifier controller for reducing harmonics of input current and control method therefor” suggests a method of additionally disposing a repeater controller and a multi-notch filter in a rectifier controller to reduce harmonic currents economically and stably without changing the hardware of the existing uninterruptible power supply, thereby lowering a harmonic ratio of an input current to reduce a failure rate of the system and peripheral devices. However, this convention art may have a problem in that an additional input current filter (e.g., a multiple notch filter) should be applied, resulting in additional installation costs.

### PRIOR ART DOCUMENT

(Patent Document) Korean Patent No. 10-2339935

### SUMMARY

Aspects of some embodiments of the present disclosure are directed to a vehicle battery output system capable of reducing a ripple component of an input current of a DC-DC converter by using a proportional resonant controller, and to a method for driving the vehicle battery output system.

Aspects of certain embodiments of the present disclosure are also directed to a vehicle battery output system capable of supplying a stable input current to the DC-DC converter without installing an additional filter for removing ripples at an input end of the DC-DC converter and without increasing a capacity of a DC link at an output end.

According to an embodiment, a vehicle battery output system includes: a DC-DC (direct current-direct current) converter configured to receive a direct current from a vehicle battery and convert the direct current into another direct current; a DC-AC (direct current-alternating current) inverter configured to convert the direct current of the vehicle battery converted by the DC-DC converter into an alternating current; a controller configured to receive an input current Iᵢₙ, an input voltage Vᵢₙ, an output voltage Vₒᵤₜ, and an output current Iₒᵤₜ and calculate a switching frequency modulation index m to generate a control signal for controlling the DC-DC converter; and a DC (direct current) link disposed between the DC-DC converter and the DC-AC inverter and including a capacitor.

In some embodiments, the controller may calculate the switching frequency modulation index m by subtracting a current frequency modulation index mᵢ from a voltage frequency modulation index mᵥ.

In some embodiments, the controller may include: a first subtractor configured to subtract the output voltage Vₒᵤₜ from a reference voltage V_{ref} to calculate an error; a voltage controller configured to receive the error from the first subtractor and calculate a voltage frequency modulation index mᵥ through frequency modulation; a proportional resonant controller configured to receive the input current Iᵢₙ and calculate a current frequency modulation index mᵢ through frequency modulation; and a second subtractor configured to calculate the switching frequency modulation index m by subtracting the current frequency modulation index mᵢ from the voltage frequency modulation index mᵥ.

In some embodiments, the vehicle battery output system may further include: an input current sensor configured to detect the input current Iᵢₙ of an input end of the DC-DC converter and output the input current Iᵢₙ to the controller; and a gate driver configured to convert an output signal of the controller into an analog signal to control the DC-DC converter.

In some embodiments, the gate driver may output a PWM (pulse width modulation) control signal based on the switching frequency modulation index m.

In some embodiments, the vehicle battery output system may further include: a voltage sensor configured to detect the output voltage Vₒᵤₜ across opposite ends of the capacitor of the DC link.

In some embodiments, the DC-DC converter may include: a switch configured to convert a DC voltage into an AC (alternating current) voltage; a transformer configured to transform the AC voltage output from the switch; and a rectifier configured to rectify the transformed AC voltage into DC.

In some embodiments, the switch may be a full bridge or a half bridge.

In some embodiments, a transfer function G_{iPR} of the input current Iᵢₙ to the voltage frequency modulation index mᵥ, which is an output of the voltage controller, may be represented by the following Equation:

$$GiPR = \frac{{i}_{i n}}{{m}_{v}} \approx \frac{{G}_{m i}}{1 + PR \cdot {G}_{m i}}$$

wherein PR is a gain of the proportional resonant controller, and Gₘᵢ is a current gain transfer function of the DC-DC converter.

In some embodiments, the switching frequency modulation index m may be represented by the following equation:

$$\frac{m}{{m}_{v}} = \frac{1}{1 + PR \cdot {G}_{m i}}$$

wherein PR is a gain of the proportional resonant controller, and Gₘᵢ is a current gain transfer function of the DC-DC converter.

In some embodiments, a gain of the proportional resonant controller may be represented by the following equation:

$$PR = {K}_{P} + \frac{2 {K}_{I} s}{{s}^{2} + {ω}_{r}^{2}}$$

wherein Kₚ is a proportional constant for the error, K_{I} is a gain at a resonant frequency, s is a frequency, and wᵣ is a resonant frequency.

According to an embodiment, a method for driving a vehicle battery output system, the vehicle battery output system including: a DC-DC (direct current-direct current) converter configured to receive a direct current from a vehicle battery and convert the direct current into another direct current; a DC-AC (direct current-alternating current) inverter configured to convert the direct current of the vehicle battery converted by the DC-DC converter into an alternating current; a controller configured to receive an input current Iᵢₙ, an input voltage Vᵢₙ, an output voltage Vₒᵤₜ, and an output current Iₒᵤₜ and calculate a switching frequency modulation index m to generate a control signal for controlling the DC-DC converter; and a DC (direct current) link disposed between the DC-DC converter and the DC-AC inverter and including a capacitor, includes the controller executing: measuring the input current Iᵢₙ and the output voltage Vₒᵤₜ; calculating an error by subtracting the output voltage Vₒᵤₜ from a reference voltage V_{ref}; calculating a voltage frequency modulation index mᵥ for controlling an output voltage by using the error between the reference voltage V_{ref} and the output voltage Vₒᵤₜ; calculating a current frequency modulation index mᵢ using the input current Iᵢₙ; calculating the switching frequency modulation index m by subtracting the current frequency modulation index mᵢ from the voltage frequency modulation index mᵥ; and generating a PWM (pulse width modulation) control signal using the switching frequency modulation index m.

In some embodiments, the method may further include: controlling the DC-DC converter by the PWM control signal.

In some embodiments, the method may further include: switching the switch by the PWM control signal.

According to one or more embodiments of the present disclosure, the ripple component of the input current of the DC-DC converter may be reduced by using the proportional resonant controller.

Furthermore, according to one or more embodiments of the present disclosure, the ripple component of the current may be reduced without installing an additional hardware filter at the input terminal end of the DC-DC converter and without increasing the capacity of the DC link. Accordingly, the cost and size of the vehicle battery output system may be reduced and vehicle fuel efficiency may be improved.

### BRIEF DESCRIPTION OF THE DRAWINGS

FIG. 1 is a circuit diagram for illustrating a vehicle battery output system according to an embodiment of the present disclosure.

FIG. 2 is a block diagram for illustrating a model constituting a control transfer function according to an embodiment of the present disclosure.

FIG. 3 is a block diagram for illustrating a control transfer function model representing a forward gain and a loop gain for obtaining an input current transfer function according to an embodiment of the present disclosure.

FIG. 4 is a graph for illustrating a gain according to a frequency of a proportional resonant controller according to an embodiment of the present disclosure.

FIG. 5 is a block diagram for illustrating a simplified model constituting a control transfer function according to an embodiment of the present disclosure.

FIG. 6 is a block diagram for illustrating a control transfer function model illustrating a loop gain of a simplified model for obtaining an input voltage loop transfer function according to an embodiment of the present disclosure.

FIG. 7 is a flowchart for illustrating a method for controlling or driving a vehicle battery output system including a proportional resonant controller according to an embodiment of the present disclosure.

FIG. 8 is a graph for illustrating a gain in which a 120 Hz frequency component is reduced by an input current control transfer function of a controller according to an embodiment of the present disclosure.

FIG. 9A is a graph for illustrating an input voltage, an input current, and an output power without using a proportional resonant controller included in a controller according to an embodiment of the present disclosure.

FIG. 9B is a graph for illustrating an input voltage, an input current, and an output power when using a proportional resonant controller of a controller according to an embodiment of the present disclosure.

### DETAILED DESCRIPTION

Hereinafter, embodiments of the present disclosure will be described in detail so that those skilled in the art may easily practice the present disclosure with reference to the accompanying drawings. Since the present disclosure may make various changes and have various embodiments, specific embodiments will be illustrated in the drawings and described in detail in the detailed description. However, this is not intended to limit the present disclosure to the specific embodiments, and it should be understood to include all modifications, equivalents, or substitutes included in the spirit and technical scope of the inventive concept of the present disclosure.

In order to clearly describe the inventive concept of the present disclosure, parts irrelevant to the description are omitted in the drawings, and like reference numbers refer to like elements. While explaining with reference to the drawings, even if an element is indicated by the same name, the reference numeral may vary in each drawing, and the reference numeral is described only for convenience of explanation, and the concept, characteristic, function or effect of each component are not to be construed as being limited by the corresponding reference numeral.

In describing each drawing, like reference numbers are used for like elements. Terms such as first and second may be used to describe various components, but the components should not be limited by the terms. These terms are only used for the purpose of distinguishing one component from another. For example, a first element may be termed as a second element, and similarly, a second element may be termed as a first element, without departing from the scope of the present disclosure. The term “and/or” includes any combination of a plurality of related listed items or any one of a plurality of related listed items.

Unless defined otherwise, all terms used herein, including technical or scientific terms, have the same meaning as commonly understood by one of ordinary skill in the art to which the present disclosure belongs.

Terms such as those defined in commonly used dictionaries should be interpreted as having meanings consistent with the meanings in the context of the related art, and unless explicitly defined in this application, they should not be interpreted in ideal or excessively formal meanings.

Throughout the specification, when a part is said to be “connected” to another part, this includes not only the case of being directly connected but also the case of being electrically connected or indirectly connected with another element therebetween. In addition, when a part is said to “include” a certain component, it means that it may further include other components, not excluding other components, unless otherwise stated, and it should be understood that the presence or addition of one or more features, numbers, steps, operations, components, parts, or combinations thereof is not excluded in advance.

As used herein, ‘unit’ or ‘module’ may be implemented by hardware or software, or both, and one unit or module may be implemented by using two or more hardware, or two or more units may be implemented by one hardware.

Hereinafter, a vehicle battery output system according to various embodiments of the present disclosure will be described in detail with reference to the accompanying drawings.

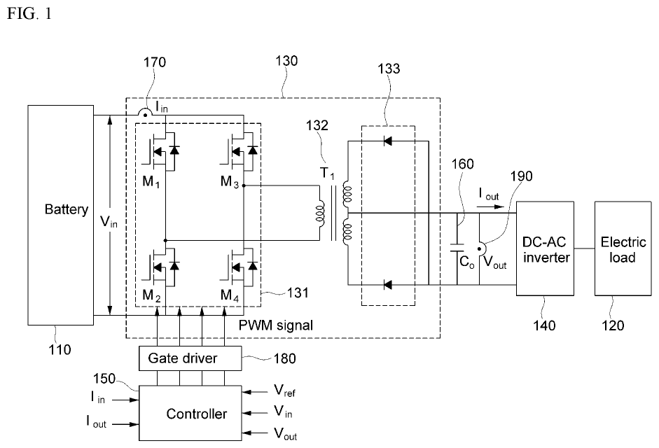

FIG. 1 is a circuit diagram for illustrating a vehicle battery output system according to an embodiment of the present disclosure.

The vehicle battery output system according to an embodiment of the present disclosure may be configured to control output of a vehicle battery 110. For example, the vehicle battery output system is configured to receive a DC power energy from the battery 110, convert the DC power energy into an AC power energy, and then supplies the converted AC power energy to a vehicle electric load 120.

The vehicle battery output system may include a DC-DC converter 130 configured to receive a direct current (DC) of the vehicle battery 110 and convert the received direct current into another direct current, a DC-AC inverter 140 configured to convert the another direct current of the vehicle battery, which has been converted in the DC-DC converter 130, into an alternating current (AC), a controller 150 configured to receive an input current Iᵢₙ, an input voltage Vᵢₙ, an output voltage Vₒᵤₜ, a reference voltage V_{ref}, and an output current Iₒᵤₜ, and generate a control signal for controlling the DC-DC converter 130, and a DC link 160 connected or disposed between the DC-DC converter 130 and the DC-AC inverter 140. The DC link 160 may include a capacitor Cₒ.

For example, the DC-DC converter 130 may be a DC power supplier applied to eco-friendly vehicles (HEV, PHEV, EV, FCV, etc.), and may be an essential device for receiving battery power from the vehicle to charge a low-voltage battery (e.g., 12 V) or supplying necessary power to electronic components. The DC-DC converter 130 may be a power converter for generating several kW of output power and may require stable control over voltage and current of an input end or terminal (primary side) and an output end or terminal (secondary side). In particular, the DC-DC converter 130 may require stable current control performance so as to protect parts such as power semiconductor devices and transformers applied therein. In such a case, if the DC link 160 where the DC-DC converter 130 and the DC-AC inverter 140 are coupled has a small capacity, a power ripple that needs to be suppressed in the DC link 160 may be transferred to the input terminal of the DC-DC converter 130 of the vehicle battery output system, thereby causing a ripple of the current of the input terminal of the DC-DC converter 130. Such a current ripple may be a problem in the EMI (Electro-Magnetic Interface) of the vehicle battery output system and may cause damage to the vehicle battery connected to the vehicle battery output system. However, the vehicle battery output system according to some embodiments of the present disclosure can reduce a ripple component of an input current of the DC-DC converter 130 by using a proportional resonant controller 153.

The vehicle battery output system may further include an input current sensor 170 configured to detect the input current Iᵢₙ of an input end or terminal of the DC-DC converter 130 and output the input current Iᵢₙ to the controller 150. The vehicle battery output system may further comprise a gate driver 180 configured to convert a signal, output from the controller 150, into an analog signal to control the DC-DC converter 130.

In addition, the vehicle battery output system may further include a voltage sensor 190 configured to detect the output voltage Vₒᵤₜ across opposite ends or terminals of the capacitor Cₒ of the DC link 160.

The DC-DC converter 130 may be, for example, but not limited to, an LLC resonant converter, and may include a switch unit 131 including four switches M₁, M₂, M₃, and M₄ (e.g. metal-oxide-semiconductor field-effect transistors (MOSFETs)) converting the DC voltage of the high-voltage battery 110 into an AC voltage through high-speed switching of the four MOSFET switches M₁, M₂, M₃, and M₄, a transformer 132 configured to transform the AC voltage output from the switch unit 131, and a rectifier 133 configured to rectify the transformed AC voltage into DC voltage.

For instance, the switch unit 131 may have full bridge configuration. When the switch unit 131 is implemented as a full bridge, the switch unit 131 may include four MOSFET switches M₁, M₂, M₃, and M₄ and may be turned on/off by the control signal input from the controller 150. The controller 150 may receive the reference voltage V_{ref}, the input voltage Vᵢₙ, the output voltage Vₒᵤₜ, and the output current Iₒᵤₜ, generate four control signals for turning on or off each of the MOSFET switches M₁, M₂, M₃, and M₄ at regular intervals, and apply the four control signals to source ends or terminals of the corresponding MOSFET switches M₁, M₂, M₃, and M₄ to perform switching control.

The switch unit 131 of the DC-DC converter 130 according to an embodiment of the present disclosure is not limited to the full bridge switch, and may adopt a half bridge switch, and any switch configuration which is capable of switching the direct current into an alternating current.

The rectifier 133 may include, for instance, but not limited to, at least one rectifier diode to rectify the AC voltage transformed by the transformer 132 into a direct current.

The DC-AC inverter 140 may convert the direct current, output from the rectifier 133, into an alternating current and apply the converted direct current to the electric load 120.

The DC link 160 may be connected or disposed between the DC-DC converter 130 and the DC-AC inverter 140. The DC link 160 may include the capacitor Co to smooth the voltage output from the rectifier 133.

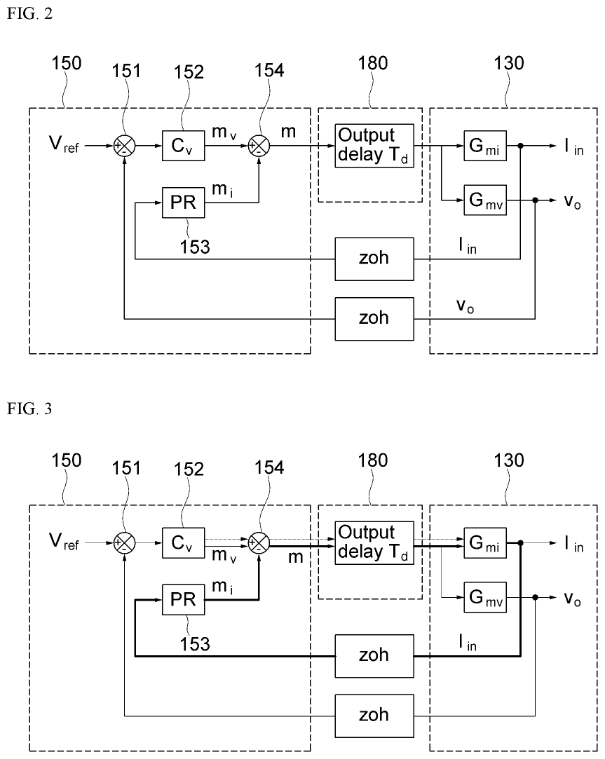

Referring to FIG. 2, the controller 150 may include a first subtractor 151 configured to receive a reference voltage V_{ref} and the output voltage Vₒᵤₜ detected by the voltage sensor 190, and subtract the output voltage Vₒᵤₜ from the reference voltage V_{ref} to calculate an error or difference therebetween; a voltage controller 152 configured to receive the calculated error or difference from the first subtractor 151 and calculate a voltage frequency modulation index mᵥ through frequency modulation; a proportional resonant (PR) controller 153 configured to receive the input current Iᵢₙ detected by the current sensor 170 and calculate a current frequency modulation index mᵢ through frequency modulation; and a second subtractor 154 configured to calculate a switching frequency modulation index m by subtracting the current frequency modulation index mᵢ, output from the proportional resonant controller 153, from the voltage frequency modulation index mᵥ, output from the voltage controller 152. For example, the reference voltage V_{ref} may be one or more preset values to be compared with the output voltage of the DC-DC converter 130.

Referring to FIGS. 1 and 2, the controller 150 may receive the input current Iᵢₙ, the reference voltage V_{ref}, and the output voltage Vₒᵤₜ and calculate the switching frequency modulation index m to generate a control signal for controlling the DC-DC converter 130.

The gate driver 180 may convert the output signal of the controller 150 into an analog signal to control the DC-DC converter 130. The gate driver 180 may receive the control signal output from the controller 150, and output a pulse width modulation (PWM) control signal for controlling the switch unit 131.

Hereinafter, a control transfer function whereby the controller 150 generates the control signal for reducing a ripple component of the input current of the DC-DC converter 130 will be described in detail.

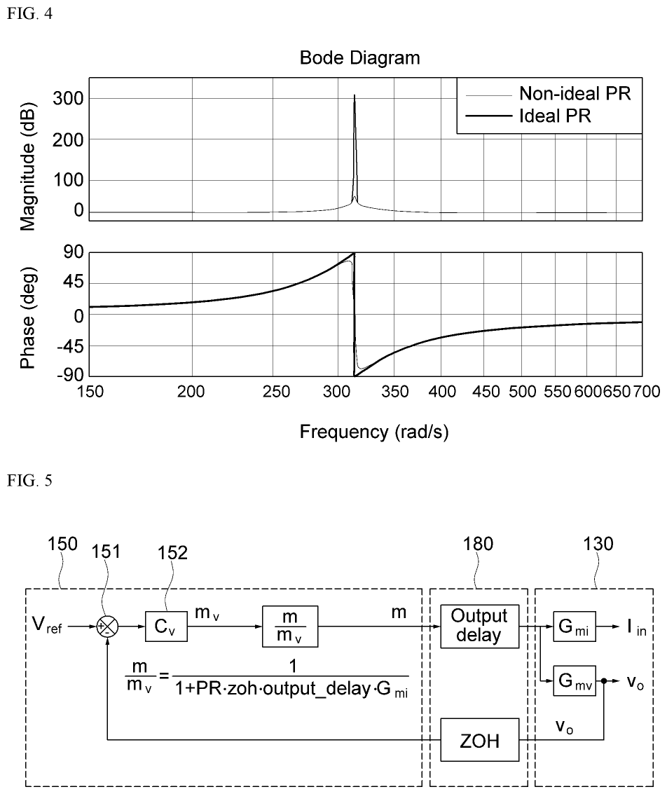

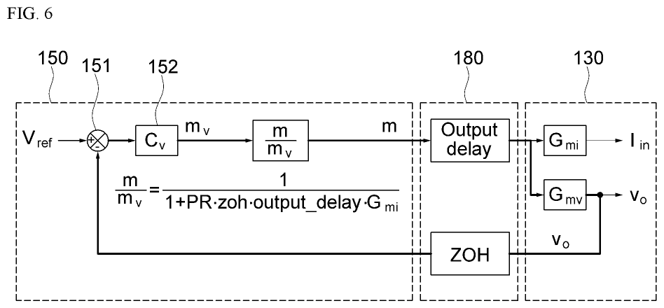

FIG. 2 is a block diagram for illustrating a model constituting a control transfer function according to an embodiment of the present disclosure. FIG. 3 is a block diagram for illustrating a control transfer function model representing a forward gain and a loop gain for obtaining an input current transfer function according to an embodiment of the present disclosure. FIG. 4 is a graph for illustrating a gain according to a frequency of a proportional resonant controller according to an embodiment of the present disclosure. FIG. 5 is a block diagram for illustrating a simplified model constituting a control transfer function according to an embodiment of the present disclosure. FIG. 6 is a block diagram for illustrating a control transfer function model illustrating a loop gain of a simplified model for obtaining an input voltage loop transfer function according to an embodiment of the present disclosure.

The control transfer function of the present disclosure may be performed or calculated in a conventional computer system. The controller 150 may be a circuit, chip, microprocessor, or any device which is capable of performing calculation or processing data.

First, referring to FIGS. 2 and 3, a transfer function G_{iPR} of the input current Iᵢₙ to the voltage frequency modulation index mᵥ, which is an output of the voltage controller 152, may be represented by Equation 1:

$$GiPR = \frac{{i}_{i n}}{{m}_{v}} = \frac{Forwardgain}{1 + Loopgain} = \frac{{G}_{m i} \cdot Td}{1 + PR \cdot Zoh \cdot Td \cdot {G}_{m i}} \qquad [ Equation 1 ]$$

where a loop gain (‘Loopgain’ of Equation 1) and a forward gain (‘Forwardgain’ of Equation 1) may be represented by Equations 2 and 3, respectively.

$$Loopgain = PR \cdot Zoh \cdot Td \cdot {G}_{m i} \qquad [ Equation 2 ]$$

$$Forwardgain = {G}_{m i} \cdot Td \qquad [ Equation 3 ]$$

where Zoh is a zero order gain, T_{d} is a control signal computation delay component, and Gₘᵢ is a current gain transfer function.

Referring to FIG. 3, the loop gain indicated by a solid bold line may be obtained by multiplying a gain PR of the proportional resonant controller 153 by Zoh, T_{d}, and Gₘᵢ. One forward gain, indicated by the dotted line, is a product of T_{d} and Gₘᵢ.

The proportional resonant controller 153 may be a controller having a high gain for a specific frequency component, which is an AC signal, and have particularly high control performance for an AC signal.

The gain PR of the proportional resonant controller 153 may be represented by Equation 4:

$$PR = {K}_{P} + \frac{2 {K}_{I} s}{{s}^{2} + {ω}_{r}^{2}} \qquad [ Equation 4 ]$$

where Kₚ is a proportional constant for the error, K_{I} is a gain at a resonant frequency, s is a frequency, and wᵣ is a resonant frequency.

Referring to FIG. 4, it may be appreciated that the proportional resonant controller 153 may have a high gain at a frequency (rad/s) of around 320, for example.

The zero order hold Zoh may represents a delay (e.g., latency) component which is generated when a continuous analog signal detected by the current sensor 170 or the voltage sensor 190 is converted into a discontinuous digital signal by the controller 150. That is, since the continuous analog signal is sampled for conversion into a digital signal at regular intervals and the value of the sampled continuous signal is maintained until the next sampling, discontinuous digital signals may have delay components compared to continuous analog signals, and Zoh may become larger at relatively lower sampling frequencies and become smaller at relatively higher sampling frequencies.

As used herein, T_{d} represents a control signal computation delay component when the controller 150 outputs the control signal for controlling the input current of the DC-DC converter 130. In general, T_{d} is a delay component that appears because a computation point in time is different from a point in time that reflects the calculation in the controller 150. In such a case, the output of the controller 150 is reflected to the DC-DC converter 130 after the current switching cycle. Accordingly, a maximum value of T_{d} is equal to the switching frequency.

As used herein, Gₘᵢ is a current gain transfer function of the DC-DC converter 130 calculated through an estimation method using a programming platform designed specifically for analyzing and designing systems and products such as Matlab.

In an embodiment of the present disclosure, when the sampling frequency for converting the continuous analog signal detected by the current sensor 170 or the voltage sensor 190 into a discontinuous digital signal in the controller 150 is much greater than the resonant frequency of the proportional resonant controller 153, the delay components Zoh and T_{d} may be negligible. Accordingly, Equation 1 may be simplified to Equation 5.

$$GiPR = \frac{{i}_{i n}}{{m}_{v}} \approx \frac{{G}_{m i}}{1 + PR \cdot {G}_{m i}} \qquad [ Equation 5 ]$$

The second subtractor 154 may subtract the current frequency modulation index mᵢ from the voltage frequency modulation index mᵥ output from the voltage controller 152, in order to obtain the switching frequency modulation index m.

The switching frequency modulation index m may be calculated by Equation 6:

$$m = {m}_{v} - {m}_{i} = {m}_{v} - PR \cdot Zoh \cdot {i}_{i n} \qquad [ Equation 6 ]$$

The current frequency modulation index mᵢ, which is an output value of the proportional resonant controller 153, may be determined by multiplying the output current Iᵢₙ by Zoh and the gain PR of the proportional resonant controller 153.

As used herein, my may represent the voltage frequency modulation index.

The switching frequency modulation index m may have a value in a range from 0 to 1, and the controller 150 may modulate with a larger switching frequency as m goes to 0 and modulate with a smaller switching frequency as m goes to 1, thereby generating a PWM control signal for switching the switch unit 131.

Equation 7 may represent the switching frequency modulation index m may be represented by Equation 7 by in which Equation 1 is applied to Equation 6.

$$[ Equation 7 ]$$

$$m = {m}_{v} - PR \cdot zoh \cdot ( \frac{{G}_{mi} \cdot output\_delay}{1 + PR \cdot zoh \cdot output\_delay \cdot {G}_{mi}} \cdot {m}_{v} ) = {m}_{v} ( 1 - PR \cdot zoh \cdot ( \frac{{G}_{mi} \cdot output\_delay}{1 + PR \cdot zoh \cdot output\_delay \cdot {G}_{mi}} ) ) = {m}_{v} \frac{1}{1 + PR \cdot zoh \cdot {output}_{delay} \cdot {G}_{mi}}$$

Accordingly, Equation 7 may be represented by Equation 8.

$$\frac{m}{{m}_{v}} = \frac{1}{1 + PR \cdot zoh \cdot output\_delay \cdot {G}_{mi}} \approx \frac{1}{1 + PR \cdot {G}_{mi}} \qquad [ Equation 8 ]$$

Referring to FIG. 5, a model for controlling the DC-DC converter 130 by the controller 150 may be simplified by using Equation 8.

Referring to FIG. 6, according to the simplified model, a voltage control loop transfer function Tᵥ may be calculated as a product of all block diagrams existing on the path in the direction of the arrow. Therefore, the voltage control loop transfer function Tᵥ may be represented by Equation 9.

$${T}_{v} = {C}_{v} \cdot \frac{m}{{m}_{v}} \cdot output\_delay \cdot {G}_{mv} \cdot zoh \qquad [ Equation 9 ]$$

Applying Equation 8 into Equation 9 may result in Equation 10:

$${T}_{v} = \frac{{C}_{v} \cdot output\_delay \cdot {G}_{mv} \cdot zoh}{1 + PR \cdot zoh \cdot output\_delay \cdot {G}_{mi}} \approx \frac{{C}_{v} \cdot {G}_{mv}}{1 + PR \cdot {G}_{mi}} \qquad [ Equation 10 ]$$

where Cᵥ may be a gain of the voltage controller 153 and Gₘᵥ may be a voltage gain transfer function of the DC-DC converter 130 calculated through an estimation method using a programming platform designed specifically for analyzing and designing systems and products such as Matlab.

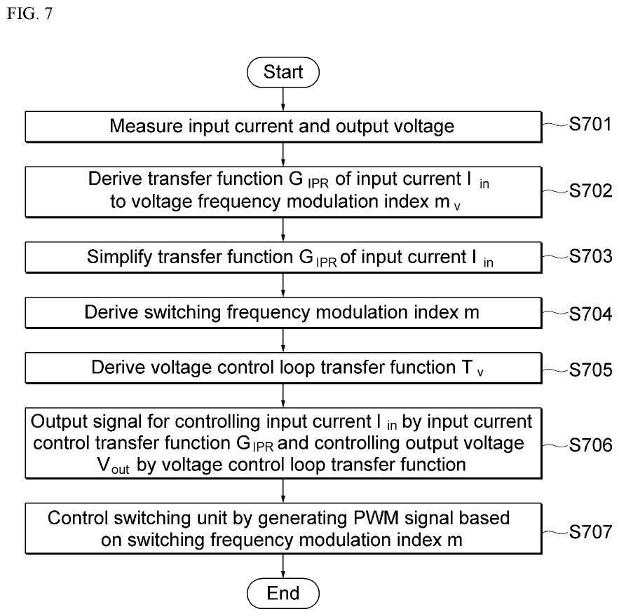

FIG. 7 is a flowchart for illustrating a method for controlling or driving a vehicle battery output system including a proportional resonant controller according to an embodiment of the present disclosure.

An input current Iᵢₙ to the DC-DC converter 130 and an output voltage Vₒᵤₜ of the DC-DC converter 130 are measured by a current sensor and a voltage sensor, respectively (Step S701).

An error or difference between the output voltage Vₒᵤₜ of the DC-DC converter 130 and a reference voltage V_{ref} is calculated by the first subtractor 151 by subtracting the output voltage Vₒᵤₜ of the DC-DC converter 130 from the reference voltage V_{ref} (Step S702).

A voltage frequency modulation index mᵥ for controlling the output voltage Vₒᵤₜ of the DC-DC converter 130 may be calculated by the voltage controller 152 by using the error or difference between the reference voltage V_{ref} and the output voltage Vₒᵤₜ of the DC-DC converter 130 (Step S703).

A current frequency modulation index mᵢ may be calculated by the proportional resonant controller 153 by using the input current Iᵢₙ to the DC-DC converter 130 (Step S704).

A transfer function G_{iPr} of the input current Iᵢₙ to the voltage frequency modulation index mᵥ, which is an output of the voltage controller 152, may be represented by Equation 11.

$$GiPR = \frac{{i}_{in}}{{m}_{v}} = \frac{Forwardgain}{1 + Loopgain} = \frac{{G}_{mi} \cdot Td}{1 + PR \cdot Zoh \cdot Td \cdot {G}_{mi}} \qquad [ Equation 11 ]$$

In Equation 11, a loop gain (‘Loopgain’ of Equation 11) and a forward gain (‘Forwardgain’ of Equation 11) may be represented by Equations 12 and 13, respectively:

$$Loopgain = PR \cdot Zoh \cdot Td \cdot {G}_{mi} \qquad [ Equation 12 ]$$

$$Forwardgain = {G}_{mi} \cdot Td \qquad [ Equation 13 ]$$

where PR is a gain of the proportional resonant controller 153.

Zoh represents a delay component which is generated when a continuous analog signal detected by the current sensor 170 or the voltage sensor 190 is converted into a discontinuous digital signal by the controller 150.

T_{d} represents a control signal computation delay component when the controller 150 outputs the control signal for controlling the input current Iᵢₙ of the DC-DC converter 130.

Gₘᵢ is a current gain transfer function of the DC-DC converter 130 calculated through an estimation method using a programming platform designed specifically for analyzing and designing systems and products such as Matlab.

In Equation 11, a sampling frequency for converting a continuous analog signal detected by the current sensor 170 or the voltage sensor 190 into a discontinuous digital signal in the controller 150 may be much higher than the resonant frequency of the proportional resonant controller 153, and therefore the delay components Zoh and T_{d} may be negligible. Accordingly, the transfer function G_{iPR} of the input current Iᵢₙ of the DC-DC converter 130 to the voltage frequency modulation index mᵥ may be simplified to Equation 15.

$$GiPR = \frac{{i}_{i n}}{{m}_{v}} \approx \frac{{G}_{mi}}{1 + PR \cdot {G}_{mi}} \qquad [ Equation 15 ]$$

The switching frequency modulation index m for switching the switch unit 131 of the DC-DC converter 130 may be calculated by the second subtractor 154 by subtracting the current frequency modulation index mᵢ from the voltage frequency modulation index mᵥ (Step S705).

In step S705, the switching frequency modulation index m may be calculated by Equations 16 and 17.

$$m = {m}_{v} - {m}_{i} = {m}_{v} - PR \cdot zoh \cdot {i}_{in} \qquad [ Equation 16 ]$$

$$[ Equation 17 ]$$

$$m = {m}_{v} - PR \cdot zoh \cdot ( \frac{{G}_{mi} \cdot output\_delay}{1 + PR \cdot zoh \cdot output\_delay \cdot {G}_{mi}} \cdot {m}_{v} ) = {m}_{v} ( 1 - PR \cdot zoh \cdot ( \frac{{G}_{mi} \cdot output\_delay}{1 + PR \cdot zoh \cdot output\_delay \cdot {G}_{mi}} ) ) = {m}_{v} \frac{1}{1 + PR \cdot zoh \cdot {output}_{delay} \cdot {G}_{mi}}$$

When simplified to a simplified control model, a voltage control loop transfer function Tv may be represented by Equation 18.

$${T}_{v} = \frac{{C}_{v} \cdot output\_delay \cdot {G}_{mv} \cdot zoh}{1 + PR \cdot zoh \cdot output\_delay \cdot {G}_{mi}} \approx \frac{{C}_{v} \cdot {G}_{mv}}{1 + PR \cdot {G}_{mi}} \qquad [ Equation 18 ]$$

In Equation 18, Cᵥ may represent a gain of the voltage controller 153 and Gₘᵥ may represent a voltage gain transfer function of the DC-DC converter 130 calculated through an estimation method using a programming platform designed specifically for analyzing and designing systems and products such as Matlab.

Next, a PWM control signal may be generated by the gate driver 180 by using the switching frequency modulation index m (Step S706).

The switch unit 131 of the DC-DC converter 130 may be controlled to be switched by the PWM control signal (Step S707).

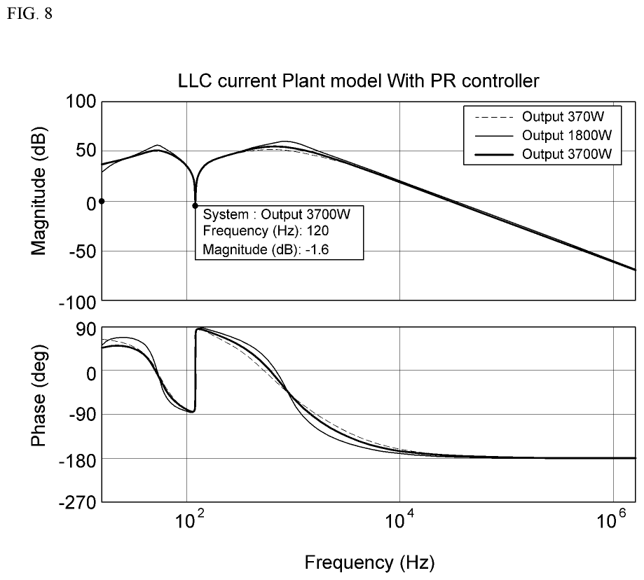

FIG. 8 is a graph for illustrating a gain in which a 120 Hz frequency component is reduced by an input current control transfer function of a controller according to an embodiment of the present disclosure.

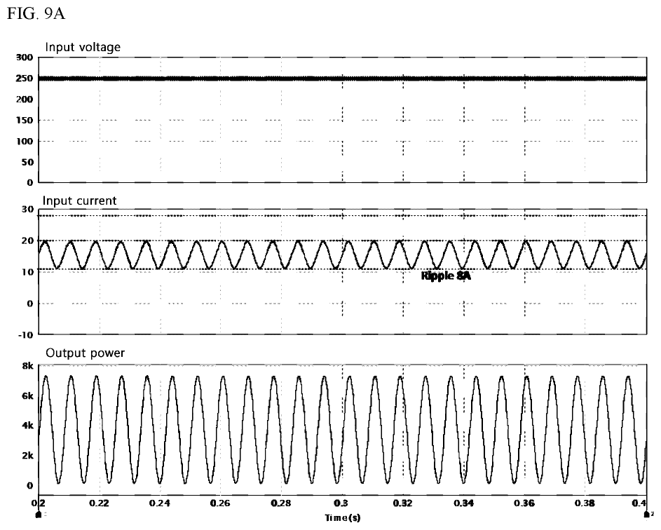

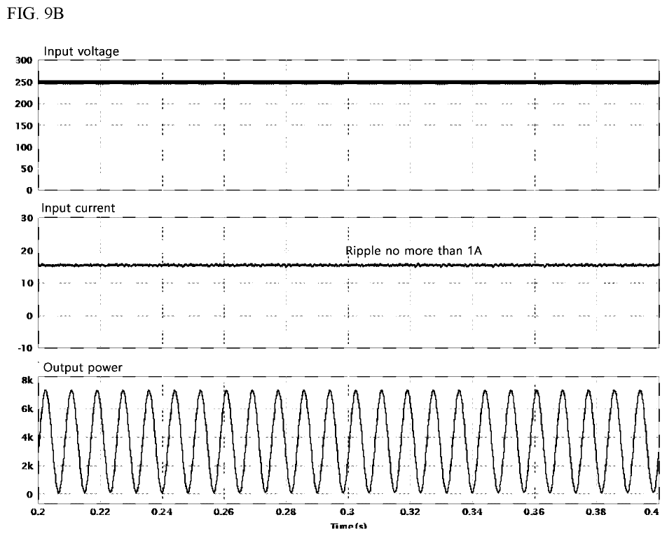

FIG. 9A is a graph for illustrating an input voltage, an input current, and an output power without using a proportional resonant controller included in a controller according to an embodiment of the present disclosure.

FIG. 9B is a graph illustrating an input voltage, an input current, and an output power when using a proportional resonant controller of a controller according to an embodiment of the present disclosure.

Referring to FIG. 8, it may be appreciated that in the proportional resonant controller 153 according to an embodiment of the present disclosure, when an alternating current is output to an AC load such as an electric component of the vehicle at a system frequency of 60 Hz, a gain (dB) may be reduced at 120 Hz which is twice the system frequency.

Accordingly, referring to FIG. 9A, when the controller does not include a proportional resonant controller, an input current Iᵢₙ exhibits an unstable waveform of an output power due to a ripple component. On the contrary, referring to FIG. 9B, when the controller includes a proportional resonant controller, a ripple component of an input current Iᵢₙ is reduced such that the waveform of the output power becomes stable, exhibiting a smooth waveform.

The above description of the present disclosure is for illustrative purposes, and those skilled in the art may understand that it may be easily modified into other specific forms without departing from the technical spirit or essential features of the present disclosure. Accordingly, the embodiments described above should be understood as illustrative in all respects and not limiting. For example, each component described as a single type may be implemented in a distributed manner, and similarly, components described as distributed may be implemented in a combined form.

The scope of the present disclosure is indicated by the following claims rather than the detailed description above, and all changes or modifications derived from the meaning and scope of the claims and equivalent concepts should be construed as being included in the scope of the present disclosure.

What is claimed is:

1. A system for controlling output of a vehicle battery, the system comprising:
a DC-DC (direct current-direct current) converter configured to convert a direct current, received from the vehicle battery, into another direct current;
a DC-AC (direct current-alternating current) inverter configured to convert the another direct current of the vehicle battery, converted by the DC-DC converter, into an alternating current;
a controller configured to calculate a switching frequency modulation index based on an input current to the DC-DC converter and an output voltage of the DC-DC converter to generate a control signal for controlling the DC-DC converter; and
a DC (direct current) link connected between the DC-DC converter and the DC-AC inverter, and including a capacitor.

2. The system of claim 1, wherein the controller is configured to calculate the switching frequency modulation index by using a difference between a current frequency modulation index and a voltage frequency modulation index.

3. The system of claim 1, wherein the controller is configured to:
calculate a difference between the output voltage of the DC-DC converter and a reference voltage;
calculate a voltage frequency modulation index using the difference between the output voltage of the DC-DC converter and the reference voltage;
calculate a current frequency modulation index using the input current to the DC-DC converter; and
calculate the switching frequency modulation index based on a difference between the current frequency modulation index and the voltage frequency modulation index.

4. The system of claim 3, further comprising:
an input current sensor configured to detect the input current to the DC-DC converter; and
a gate driver configured to convert the control signal of the controller into an analog signal to control the DC-DC converter.

5. The system of claim 4, wherein the gate driver is configured to output a PWM (pulse width modulation) control signal based on the switching frequency modulation index.

6. The system of claim 4, further comprising:
a voltage sensor configured to detect the output voltage of the capacitor of the DC link.

7. The system of claim 1, wherein the DC-DC converter comprises:
a switch unit configured to convert a DC voltage into an AC (alternating current) voltage;
a transformer configured to transform the AC voltage output from the switch unit; and
a rectifier configured to rectify the transformed AC voltage into a DC voltage.

8. The system of claim 7, wherein the switch unit has a full bridge configuration of switches.

9. The system of claim 7, wherein the switch unit has a half bridge configuration of switches.

10. The system of claim 3, wherein a transfer function of the input current to the voltage frequency modulation index is represented by an equation:
$$GiPR = \frac{{i}_{i n}}{{m}_{v}} \approx \frac{{G}_{mi}}{1 + PR \cdot {G}_{mi}}$$
wherein G_{iPR} is the transfer function of the input current to the voltage frequency modulation index, iᵢₙ is the input current to the DC-DC converter, my is the voltage frequency modulation index, PR is a gain for calculating the current frequency modulation index, and Gₘᵢ is a current gain transfer function of the DC-DC converter.

11. The system of claim 3, wherein the switching frequency modulation index is calculated using an equation:
$$\frac{m}{{m}_{v}} = \frac{1}{1 + PR \cdot {G}_{mi}}$$
wherein m is the switching frequency modulation index, mᵥ is the voltage frequency modulation index, PR is a gain for calculating the current frequency modulation index, and Gₘᵢ is a current gain transfer function of the DC-DC converter.

12. The system of claim 11, wherein the gain for calculating the current frequency modulation index is calculated using an equation:
$$PR = {K}_{P} + \frac{2 {K}_{I} s}{{s}^{2} + {ω}_{r}^{2}}$$
wherein PR is the gain for calculating the current frequency modulation index, Kₚ is a proportional constant for the difference between the current frequency modulation index and the voltage frequency modulation index, K_{I} is a gain at a resonant frequency, s is a frequency, and wₜ is the resonant frequency.

13. A method for driving a system comprising a DC-DC (direct current-direct current) converter configured to convert a direct current received from a vehicle battery into another direct current, a DC-AC (direct current-alternating current) inverter configured to convert the converted another direct current into an alternating current, and a controller configured to control the DC-DC converter, the method comprising:
measuring an input current to the DC-DC converter and an output voltage of the DC-DC converter;
calculating a difference between the output voltage of the DC-DC converter and a reference voltage;
calculating a voltage frequency modulation index for controlling the output voltage of the DC-DC converter by using the difference between the output voltage of the DC-DC converter and the reference voltage;
calculating a current frequency modulation index using the input current to the DC-DC converter;
calculating a switching frequency modulation index using a difference between the current frequency modulation index and the voltage frequency modulation index; and
generating a control signal for controlling the DC-DC converter using the switching frequency modulation index.

14. The method of claim 13, wherein:
the voltage frequency modulation index is calculated through frequency modulation, and
the current frequency modulation index is calculated through frequency modulation.

15. The method of claim 13, further comprising:
controlling the DC-DC converter by a PWM (Pulse Width Modulation) control signal.

16. The method of claim 15, further comprising:
by a switch unit including one or more switches, converting a DC voltage into an AC (alternating current) voltage;
by a transformer, transforming the AC voltage output from the switch unit; and
by a rectifier, rectifying the transformed AC voltage into a DC voltage.

17. The method of claim 16, further comprising switching the switches by the PWM control signal.

18. The method of claim 14, wherein a transfer function of the input current to the voltage frequency modulation index is represented by an equation:
$$GiPR = \frac{{i}_{in}}{{m}_{v}} \approx \frac{{G}_{mi}}{1 + PR \cdot {G}_{mi}}$$
wherein G_{iPR} is the transfer function of the input current to the voltage frequency modulation index, iᵢₙ is the input current to the DC-DC converter, mᵥ is the voltage frequency modulation index, PR is a gain of the proportional resonant controller, and Gₘᵢ is a current gain transfer function of the DC-DC converter.

19. The method of claim 14, wherein the switching frequency modulation index is calculated using an equation:
$$\frac{m}{{m}_{v}} = \frac{1}{1 + PR \cdot {G}_{mi}}$$
wherein m is the switching frequency modulation index, mᵥ is the voltage frequency modulation index, PR is a gain for calculating the current frequency modulation index, and Gₘᵢ is a current gain transfer function of the DC-DC converter.

20. The method of claim 19, wherein the gain for calculating the current frequency modulation index is calculated by using an equation:
$$PR = {K}_{P} + \frac{2 {K}_{I} s}{{s}^{2} + {ω}_{r}^{2}}$$
wherein PR is the gain for calculating the current frequency modulation index, Kₚ is a proportional constant for the difference between the current frequency modulation index and the voltage frequency modulation index, K_{I} is a gain at a resonant frequency, s is a frequency, and wᵣ is the resonant frequency.
